(19) United States
(12) Patent Application Publication
(10) Pub. No.: US 2005/0278458 A1
(43) Pub. Date: Dec. 15, 2005

(54) Analysis services database synchronization

(75) Inventors: Alexander Berger, Sammamish, WA (US); Edward Melomed, Kirkland, WA (US); Sergei Gringauze, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 10/864,745

(22) Filed: Jun. 9, 2004

(51) Int. Cl. G06F 17/00

(52) U.S. Cl. 709/248

(57) ABSTRACT

Systems and methodologies are provided for synchronizing a state of a target serve with that of a source server. During such synchronization process users that interact with the target server can still query data therefrom, with no interruption of service, and are switched to a new state of database upon completion of the synchronization process. Additionally, a transaction consistency is maintained and system administrators are enabled to change location of the data caches, and distribute data and/or applications among a plurality of server configurations by the synchronization process.

### TECHNICAL FIELD

The present invention relates generally to synchronization of data between servers, and more particularly to systems and methods that facilitate efficient restoration and back up of server systems in a transactional manner in various applications (e.g., OLAP environments, data mining and the like.)

### BACKGROUND OF THE INVENTION

Increasing advances in computer technology (e.g., microprocessor speed, memory capacity, data transfer bandwidth, software functionality, and the like) have generally contributed to increased computer application in various industries. Ever more powerful server systems, which are often configured as an array of servers, are often provided to service requests originating from external sources such as the World Wide Web, for example. As local Intranet systems have become more sophisticated thereby requiring servicing of larger network loads and related applications, internal system demands have grown accordingly as well. As such, much business data is stored in databases, under the management of a database management system (DBMS). For such DBMS systems, a demand for database transaction processing capacity in large installations has been growing significantly.

A large percentage of overall new database applications have been in a relational database environment. Such relational database can further provide an ideal environment for supporting various forms of queries on the database. Accordingly, the use of relational and distributed databases for storing data has become commonplace, with the distributed databases being databases wherein one or more portions of the database are divided and/or replicated (copied) to different computer systems.

At the same time, typically organizations have tried to use relational database management systems (RDBMSs) for the complete spectrum of database applications. Nonetheless, it has become apparent that major categories of database applications exist that are not suitably serviced by relational database systems—e.g., RDBMSs do not efficiently service ad hoc data access and analysis; such as in a multiple vendor or multiple site environment—and there is usually a need for a “stand-off” analysis tool such as on-line analytical processing (OLAP).

The essence of OLAP server technology is fast, flexible data summarization and analysis. In general, OLAP applications have query and response time characteristics which set them apart from traditional on-line transaction processing (OLTP) applications. Specialized OLAP servers are designed to give analysts the response time and functional capabilities of sophisticated personal computer programs with the multi-user and large database support they require. These multidimensional views are supported by multidimensional database technology. Further, these multidimensional views provide the technical basis for the calculations and analysis required by Business Intelligence applications. As such, OLAP applications are becoming popular tools as organizations attempt to maximize the business value of the data that is available in ever increasing volumes from operational systems, spreadsheets, external databases and business partners.

However, merely viewing this data is not sufficient. Business value comes from using it to make better informed decisions more quickly, and creating more realistic business plans. Further, OLAP application requirements consist of much more than just viewing history with different levels of aggregation. Typically, the purpose of analysis service is often to make decisions about the future, not simply to review the past. Accordingly, accessing an up-to-date and consistent view of data to users becomes essential.

Yet, providing a consistent form of data to users of such systems, while at the same time updating the various servers involved, is a challenging task. Typically, processing queries to users can be interrupted when production servers of such units are staged or synchronized with the source servers. In addition, during such synchronization data transferred to the target server, in general follows an exact partition replica of the source server. Thus, users' ability in configuring applications is limited.

Therefore, there is a need to overcome the aforementioned deficiencies associated with conventional systems and methodologies related to database operations.

### SUMMARY OF THE INVENTION

The following presents a simplified summary of the invention in order to provide a basic understanding of one or more aspects of the invention. This summary is not an extensive overview of the invention. It is intended to neither identify key or critical elements of the invention, nor to delineate the scope of the present invention. Rather, the sole purpose of this summary is to present some concepts of the invention in a simplified form as a prelude to the more detailed description that is presented hereinafter.

The present invention provides for systems and methods of efficiently synchronizing a state between a target server and a source server in a transactional manner, such that clients interacting with the target server can still query data therefrom, without an interruption of service during the synchronization process. In addition, such synchronization maintains a transaction consistency, while at the same time enabling users to change location of the data caches, and distribute data and/or applications among a plurality of server configurations by the synchronization process. The target server (e.g., the server that a synchronized copy of the database will be copied to; such as a production server) and the source server (e.g., the server that contains the data to be copied; such as a staging server), can be partially synchronized, or totally synchronized as designated by system administrators.

According to one aspect of the present invention, a synchronization algorithm is employed between the production server (e.g., the target server) and the staging server (e.g., the source server) as part of a multi-dimensional object based environment. In such environment, the production server can run uninterruptedly to serve users' queries, while the staging server can be employed by system administrators for testing data, security applications, metadata updates and the like. The Synchronization algorithm can be performed as a single command operation, upon the target server sending a command to the source server, wherein initially a state of two databases is compared; one on the target machine and one on the source machine. In a related aspect an optimization function can also be employed so that the source server need not transfer all its content during a synchronization stage. The source server can initially receive (e.g., via a log record) contents of the target server, and subsequently sort out a difference therebetween. As such, the target server can prepare an image of its contents, to be forwarded to the source server. The source server can then determine a difference of contents for the target server with its own contents (e.g., via a differentiator component as described in detail infra), and send such difference back to the target server. Accordingly, redundant processing can be mitigated and a transactional nature for synchronization, such as enabling users to query data during the synchronization process, can typically be maintained.

In another aspect of the present invention, increased configuration flexibility can be provided by enabling a user to build applications and change location of data during the synchronization process. For example, for on-line analytical processing systems (OLAP) with multi dimensional views of aggregate data, the processing stage can be performed on one set of processing servers, while users can use the data on another set of machines having different requirements and with a different configuration. As such, flexibility can be enhanced while from a storage point of view, users can build system configuration that need not be exact replicas of source caches. Also, synchronization of any element on any server or a partition thereof can be scheduled to occur at specific times or on demand; for example depending on location of server and associated time zone.

According to a methodology of the present invention, the synchronization process can initiate when system administrators send a synchronize command to the target server. Next, the target server sends an “InternalSynch” command to the source server, as well as a log record that contains a description of the files for state of database before synchronization. For example an image of the target server database (e.g. cachces, dimensions for OLAP, and the like) before synchronization is performed. Next, the target serve can “pull” data from the source server when it connects thereto, with the source server managing and coordinating the synchronization process. Accordingly, the source server can be performing a “back up” operation while the target server is performing a “restore” operation. At the end of the synchronization process the target server will contain identical copies of the source database, to the extent designated by users (e.g., partial or total synchronization.)

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE DRAWINGS

FIG. 1 illustrates a schematic block diagram for synchronizing a state between a target server and a source server according to one aspect of the present invention.

FIG. 2 illustrates a block diagram of a client—server network, wherein the production server can be synchronized in accordance with an aspect of the present invention.

FIG. 3 is another schematic block diagram for a synchronization that enables partition reconfiguration in accordance with aspect of the present invention.

FIG. 4 illustrates a particular partitioning reconfiguration based on a synchronization procedure in accordance with an aspect of the present invention.

FIG. 5 is an exemplary flow chart for a synchronization procedure in accordance with an aspect of the present invention.

FIG. 6 illustrates a flow chart of a related methodology according to one aspect of the present invention.

FIG. 7 illustrates a further schematic block diagram in accordance with an aspect of the present invention.

FIG. 8 illustrates a particular flow chart for implementing a methodology according to one aspect of the present invention.

FIG. 9 illustrates an exemplary operating environment in which the present invention can function.

FIG. 10 is a schematic block diagram illustrating a suitable computing environment that can employ various aspects of the present invention.

FIG. 11 illustrates yet another example operating environment in which the present invention can function.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal).

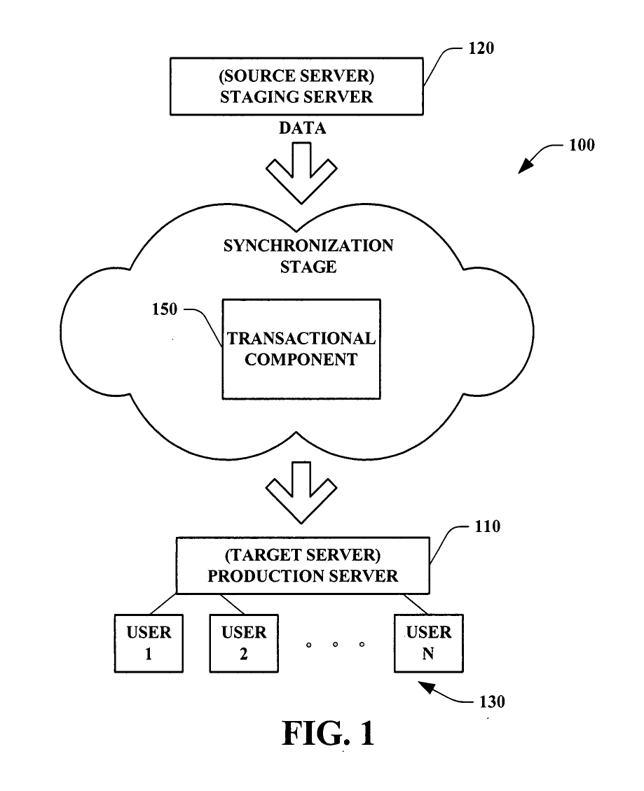

The present invention provides for an efficient synchronization of a source server and a target server while maintaining a transaction consistency and enabling users to change location of the data caches, and distribute data and/or applications among a plurality of server configurations by the synchronization process. Referring initially to FIG. 1, a system block diagram 100 is illustrated according to one aspect of the present invention. The system 100 can include a target server, such as a production server 100, and a source server, such as a staging server 120. It is to be appreciated that any of the production and staging servers 110, 120 can itself comprise a plurality of other distributed server units and configurations. The production server 110 can process user queries, when interacting with a plurality of users 1 to N (N being an integer) 130. Likewise, the staging server 120 can be employed by system administrators for testing data; security applications, metadata updates, distribution of simulated users relative to a desired test load and adjusting the intensity of the load test (e.g. number of simulated users directed to the server per unit of time); setting up various scenarios of load testing that include a plurality of test mixes, load profiles and user profiles that are statistically determined based on records of web logs. As such, the staging server 120, which represents the source server, can be configured for use by a limited number of users (e.g., system administrators) with specific requirements of security, partitioning, hard ware and software configurations and the like. On the other hand, the production server 110, can be configured with different requirements to process a plurality of user queries.

In accordance with an aspect of the present invention, the state of the production server 120 can be synchronized with that of the staging server 110 via a transactional component 150, which can typically assure that users can still query data with no interruption of service during the synchronization process. As such, synchronization can be provided in a transactional manner, for example users have the ability to issue queries to the production server 110 as well as performing other operations, during the synchronization process and while data is being transferred from the staging server 120 to the production server 110.

An exemplary Data Definition Language (DDL) for initiating the synchronization process between the source server and the target server can for example include:

<Synchronize>

<source>

<ConnectionString> Connection

string</ConnectionString>

<object>object_ref</object>

</source>
[<Locations>

[<Location >

[<DatasourceID>Datasource ID</DatasourceID>]
[<ConnectionString>Analysis Server

Connection string</ConnectionString>]

[<Folders>

[<Folder>

<Original>old folder</Original>
<New>new folder</New>

</Folder>]

<Folders>]

</Location>]

</Locations>]
[<SynchronizeDirectWriteBack>true/false</
SynchronizeDirectWriteBack >]
[<SynchronizeSecurity> CopyAll | SkipMembership |
IgnoreSecurity</SynchronizeSecurity>]
[<ApplyCompression>true/false</ApplyCompression >]

</Synchronize>

Accordingly, the production server 110 can “pull” the data from the staging server; for example all modifications and changes built into the staging server as a result of various testing procedures, trials, and processing can now be brought into the production server and implemented into the operations machine. The Synchronization algorithm can be performed as a single command operation upon the production server 110 sending a command to the staging server 120, wherein initially a state of two data bases is compared; one on the production server 110 and one on the staging server 120. Various optimization functions, as described in more detail infra can also be employed so that the staging server 120 need not transfer all its content during a synchronization stage. The staging server 120 can initially receive (e.g., via a log record) contents of the production server 110, and subsequently sort out a difference between the production server 110 and the staging server 120. As such, the production server can prepare an image of its contents and forward that to the staging server. The staging server 120 can then determine a difference of contents for the target server with its own contents (e.g., via a differentiator component as described in detail infra), and send such difference back to the production server

As another example, the production server 110 can be required to be updated with new data at predetermined intervals, e.g., on a monthly basis by bringing in data for the new month; and while data for the new month is being transferred users still maintain access to data of the old month and upon completion of data transfer users will then switch to the new state of the data. Accordingly, a consistency of transaction can be maintained during the synchronization process, and users do not observe inconsistencies in their view of the data. The synchronization according to the present invention can typically ensure that each transaction produces a correct state, and that each transaction begins when the database is in a correct state, for example it generally adheres to the ACID (Atomicity, Consistency, Isolation and Durability) standards.

In general, Atomicity can refer to a feature that: either the results of the transaction (i.e., changes to the database) are all properly reflected in the database, or none of them are. When a transaction commits, all changes made to the database by the transaction are durably stored, leaving the database in a consistent state. When a transaction aborts, any changes made to the database by the transaction are backed out, once again leaving the database in a consistent state. Similarly, consistency controls a state of the data should a failure occur. Thus, a transaction must bring the database from one consistent state to another consistent state. Likewise, isolation in general means that the events within a transaction must be hidden from other transactions running concurrently, and that concurrent transactions must not interfere with each other. Put differently, they execute as if they had the database to themselves. Finally, durability typically refers to a feature that once a transaction has been completed and has committed its results to the database, the system must guarantee that these results survive any subsequent malfunctions.

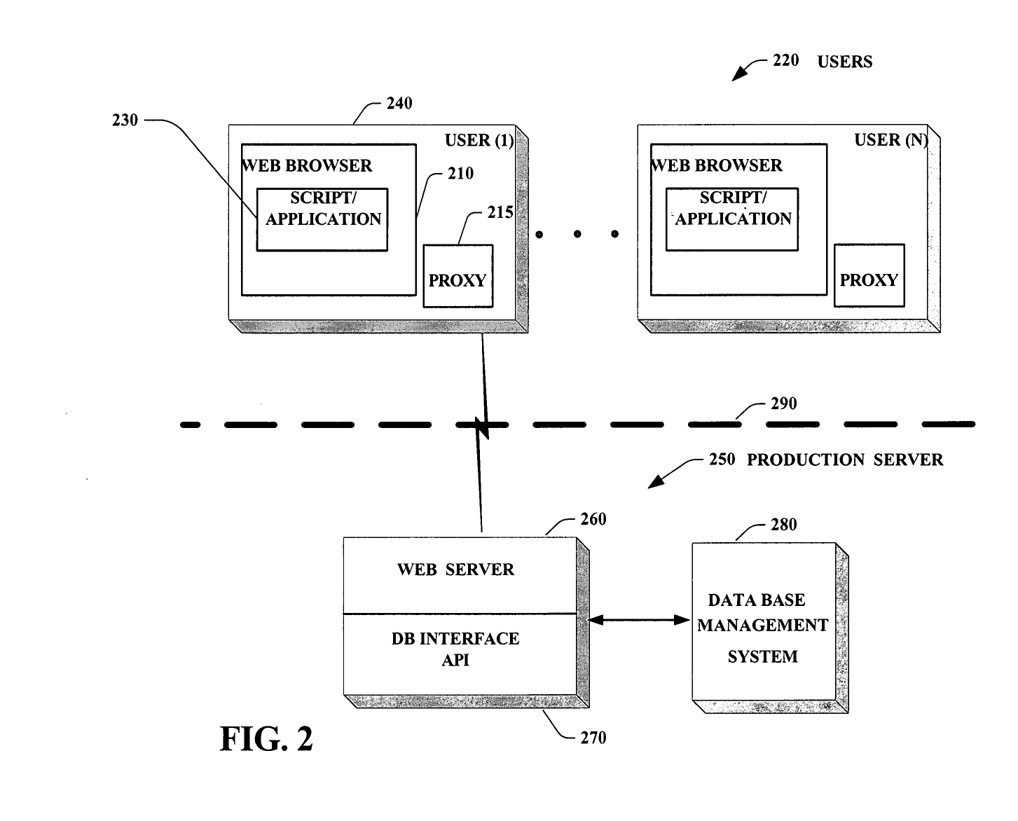

Typically, synchronization is performed on the production server without a service interruption to user clients 1 thru N (N being an integer) illustrated in FIG. 2. For example, user clients 1 thru N have the ability to issue queries to the production server 260 as well as performing other operations, during the synchronization process and while data is being transferred from the staging server (not shown) to the production server 250.

As illustrated, running on the client side 220 can be a client process, for example, a web browser 210. Likewise, running on the production server side 250 can be a corresponding server process, for example, a web server 260. In addition, embedded in the Web Browser 210 can be a script or application 230, and running within the run-time environment 240 of the client computer 220, can exist a proxy 215 for packaging and unpacking data packets formatted in accordance with various aspects of the present invention. Communicating with the production server 250 is a database management system (DBMS) 280, which manages access to the associated database. The DBMS 280 and the database (not shown) can be located in the server itself, or can be located remotely on a remote database server (not shown). Running on the Web server 260 can be a database interface Applications Programming Interface (API) 270, which provides access to the DBMS 280. The client computer 220 and the server computer 250 can communicate with each other through a network 290. When the client process, e.g., the Web browser 210, requests data from a database of the production server 250, the script or application 230 issues a query, which is sent across the network (e.g. internet) 290 to the server computer 250, where it is interpreted by the server process, e.g., the Web server 260. The client's 220 request to production server 250 can contain multiple commands, and a response from production server 250 can return a plurality of result sets. Responses to client commands that are returned can be self-describing, and record oriented; (e.g. the data streams can describe names, types and optional descriptions of rows being returned.)

On the client side 220 the data can be a login record that the production server side 250 can accept. When a connection is desired, the client 220 can send a login to the server. Even though the client 220 can have more than one connection to the production server 250, each connection path can be established separately and in the same manner. Once the server 250 has received the login record from the client 220 it will notify the client that it has either accepted or rejected the connection request. When the production server 250 is being synchronized with new data, the users can continue with uninterrupted service, and upon completion of the synchronization process are switched to the new state without an inconsistency in a view of the data.

At the same time, for on-line analytical processing systems (OLAP) with multi dimensional views of aggregate data, the processing stage can be performed on one set of processing servers, while users can use the data on another set of machines having different requirements and with a different configuration. For example, computing units employed for processing of data can be required to have specific security protocols, while employing fast and reliable cache and memory configurations. While other computing units used for responding to user queries can require different operation characteristics; such as having a different security protocol, performing rapid communications and the like. Accordingly, the present invention can provide efficient synchronization between such dual operational requirements and configurations.

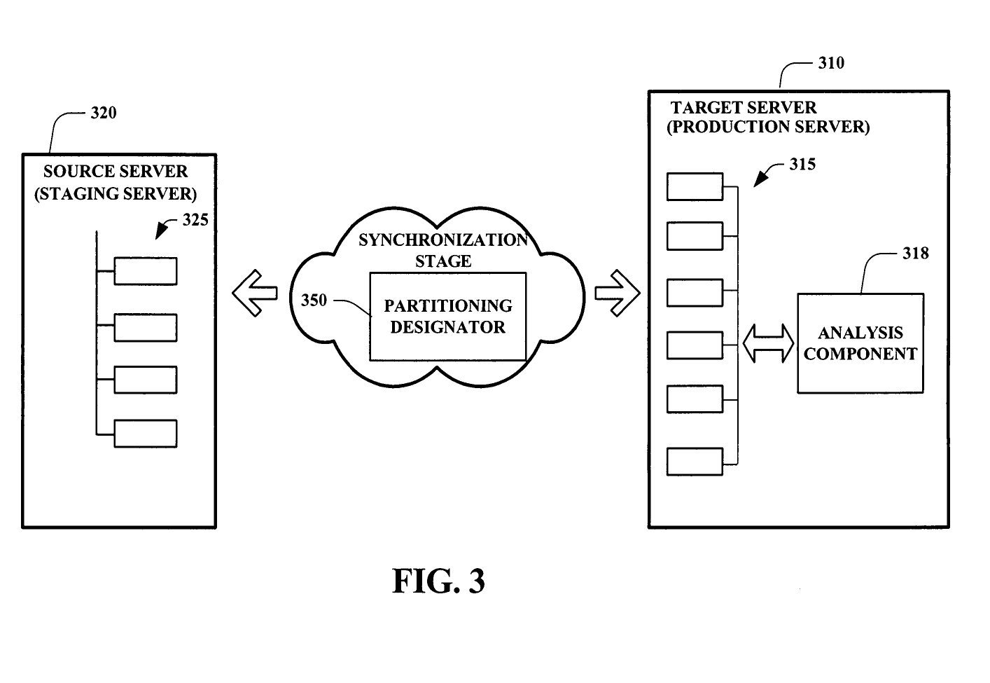

Typically, in such multidimensional object based environments OLAP variants can be leveraged to create multiple query sourced about a database. Moreover, such environments, by efficiently converting multidimensional object based on the data source to an OLAP cache, such as a multidimensional OLAP (MOLAP), can enable users to have queries analyzed rapidly while at the same time maintaining a capability to access the data source in real time. Referring now to FIG. 3 a production server 310 and the staging server 320 can comprise of various caching systems 315, 325 with databases capable of accepting updates. The caching system 315 for example, can further interact with an analysis component 318. In turn, such analysis components can further comprise cache interface (not shown) and multi dimensional cache interface (not shown). These interfaces can provide access from the analysis component 318 to the cache and/or multidimensional objects depending upon a desired query response (e.g., seeking an appropriate cache for an appropriate response.) In addition, various subset interfaces can also be employed to provide access to subsets of the cache and multi dimensional object while other parts of the cache and/or multidimensional objects are being updated. The cache can be comprised of information derived form the multi dimensional objects that are based on the database. The multidimensional objects need not be part of the caching system, and can for example be part of the database management system.

In addition, the analysis component can further comprise a query interpreter that can handle multiple query inputs. For example, this can include any number of inputs, such as User #1 input, User #2 input, and User #N input (N being an integer). Each user input can constitute at least one query which the query interpreter analyzes. For example, if the first User #1 input contains Query #1 with a dimension of “product info” and database status relative to that information of “database stable”, the query interpreter can direct that access to the associated terminal for accessing the respective cache. Such cache can be a multidimensional OLAP cache with fast response time and the like. If the second User #2 input contains Query #2 with a dimension of “demographics” and database status relative to that information of “database updating”, the query interpreter can direct that access to a real-time terminal for accessing the multidimensional objects related thereto. The multidimensional objects' characteristics can include real-time data access and the like. Likewise, if the N^{th} User #N input has a dimension of “financial data” and a database status relative to that information of “database updating”, the query interpreter can direct that access to its real-time terminal for accessing the multidimensional objects. As such, the caching system 325 can provide a user with desired responses without having active user input as to which cache is to be utilized. However, the present invention does not preclude utilizing user and/or system inputs to determine how and/or when to cache. It is to be appreciated that the discussion supra is an exemplary arrangement for a multi dimensional object environment and other relational database configurations are also well within the realm of the present invention.

As illustrated in FIG. 3, the partitioning designator component 350 can provide for increased configuration flexibility when a state of data between the target server 310 and the source server 320 is synchronized. For example users can build system configurations and applications on the target server 310 that need not be exact replicas of source server caches. Also, synchronization of elements on any server or a partition thereof can be scheduled to occur at specific times or on demand; for example depending on location of server and associated time zone.

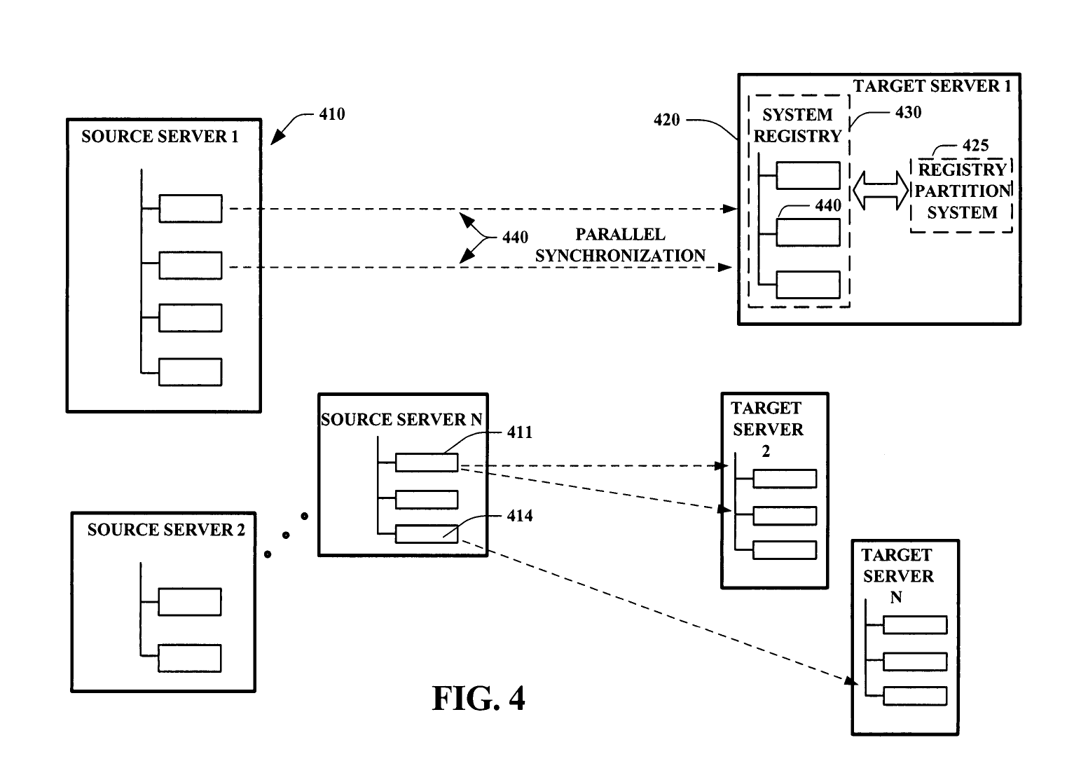

Referring now to FIG. 4 a partitioning reconfiguration according to one aspect of the present invention is illustrated. The target server 420 can include a registry partition system 425 that provide access to stored information, and facilitates a generic (e.g. application and/or operating system independent) manner for partitioning the system registry 430. A customized view of the system registry 430 can be provided to the components and applications of the source server 410. Such view can be customized based on version, computer configuration, user's preference and/or other suitable information. The system registry 430 can be represented, for example, by a hierarchical tree and an application can use any node in the tree supplying a complete path from root to any node in the tree. In addition, a node in a partition data store of the system registry can have a set of attributes and/or rules that define how remapping is to be performed in the target server based on a user's preference.

The registry partition 425 can also store redirection information associated with a user's desired applications on system registry 430. Prior to synchronization, information on the registry partition 425 for the target server 420 can be provided to the source server 410. For example, an interception component (not shown) can receive requests from the source server 410 to access system registry 430 and partition data store 440, and can return information associated with such partitioning back to the source server 410. Subsequently, desired partitioning spaces can be created in the registry partition system 430 based on a user's preference and based on the interception's component determination of whether remapping contents of the target system 420 is appropriate. As such, users are enabled to change location of the data caches, and distribute data and/or applications among a plurality of server configurations by the synchronization process. Thus, flexibility can be enhanced while from a storage point of view, users can build system configuration that need not be exact replicas of source caches. The users can also specify a partial synchronization of the source server with data from the source server transferred thereto. For example, users can be provided with an option to preserve desired data without overwriting them during the synchronization process, e.g. provide for partial or full synchronization. As illustrated, for example a user can chose block 411, 414 from source server N for synchronization and transfer such synchronized data to desired units on the target server. Thus, synchronization of a distributed configuration can be achieved by issuing a single command, and for any element of the database. Accordingly, synchronization of remote partitions can be enabled, wherein for each remote data source ID the target data source string is specified, and a “sync” command is issued for each remote data source. Moreover, parallel synchronization means (e.g. 440) can be established with synchronization occurring in parallel at faster speed. Various data compression parameters can also be employed according to the compression property for traffic of severs.

An exemplary DDL for location mapping can for example include:

[<Locations>

[<Location >

[<Folders>

[<Folder>

<Original> c:\oldfolder</Original>
<New>new folder</New>

</Folder>]

<Folders>]

</Location>]

</Locations>]

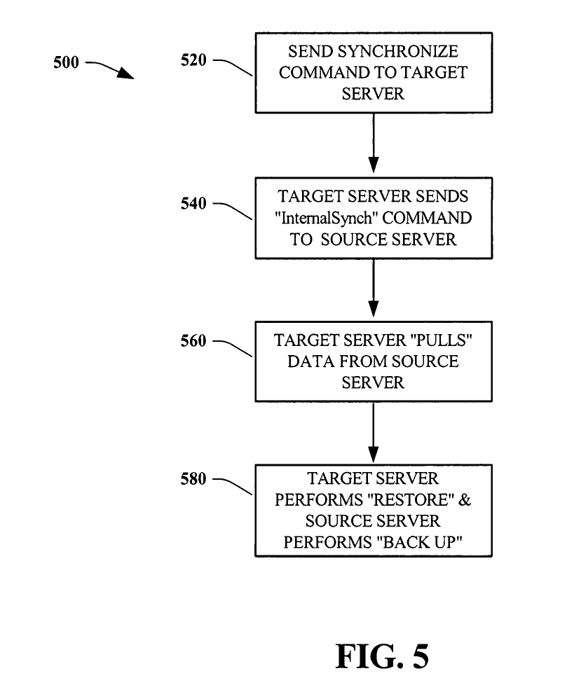

FIG. 5 illustrates a related methodology in accordance with an aspect of the present invention. Initially, and at 520 a system administrator that desires synchronization for a database sends an initial synchronization command to the target server. As described earlier, such a command can request a partial or total synchronization of the source server with the target server. Subsequently, and at 540 the target server can send an Internal Synch command to the server. Typically, the target server is responsible for “pulling” data from the source server and managing related coordination. The target server can also send a log record for the state of the database, in conjunction with an optimization feature, described in detail infra. For example, an image of the target server database before synchronization, e.g. cachces, dimensions for OLAP, and the like can be sent to the source server. As such the target server can then “pull” data from the source server when it connects thereto, with the source server managing and coordinating the synchronization process. Next, at 580 the source server can be performing a “back up” operation while the target server is performing a “restore” operation. At the end of the synchronization process the target server will contain identical copies of the source database, to the extent designated by users (e.g., partial or total synchronization.)

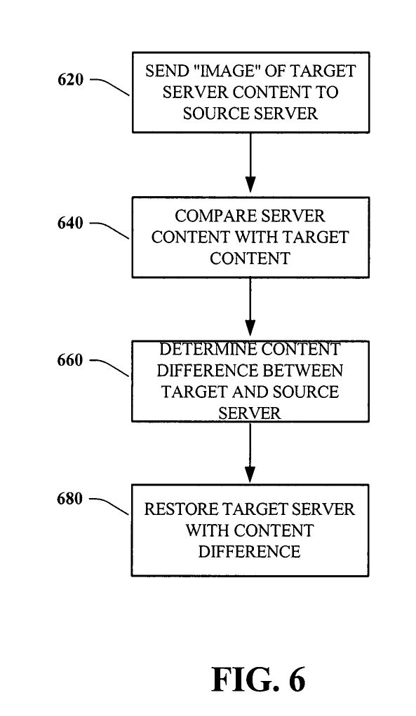

FIG. 6 illustrates another methodology in accordance with an aspect of the present invention, wherein an optimization feature can be employed, to mitigate redundant restore and back up that can occur in the target server and the source server respectively. Upon a synchronization command being issued by a system administrator, initially at 620 a content of the target server is being sent to the source server. Such can be in the form of forwarding an image of the target contents, and/or preparing a log record. Subsequently, a state of the source server and that of the target server can be compared at 640. Next, and at 660 a determination is made as to the difference between the contents for the target server and the source (e.g. via a differentiator component of the synchronization process). Accordingly, the target sever can then be updated and restored with only new information at 680, thus mitigating redundant processing and preserving system resources.

While the exemplary method is illustrated and described herein as a series of blocks representative of various events and/or acts, the present invention is not limited by the illustrated ordering of such blocks. For instance, some acts or events may occur in different orders and/or concurrently with other acts or events, apart from the ordering illustrated herein, in accordance with the invention. In addition, not all illustrated blocks, events or acts, may be required to implement a methodology in accordance with the present invention. Moreover, it will be appreciated that the exemplary method and other methods according to the invention may be implemented in association with the method illustrated and described herein, as well as in association with other systems and apparatus not illustrated or described.

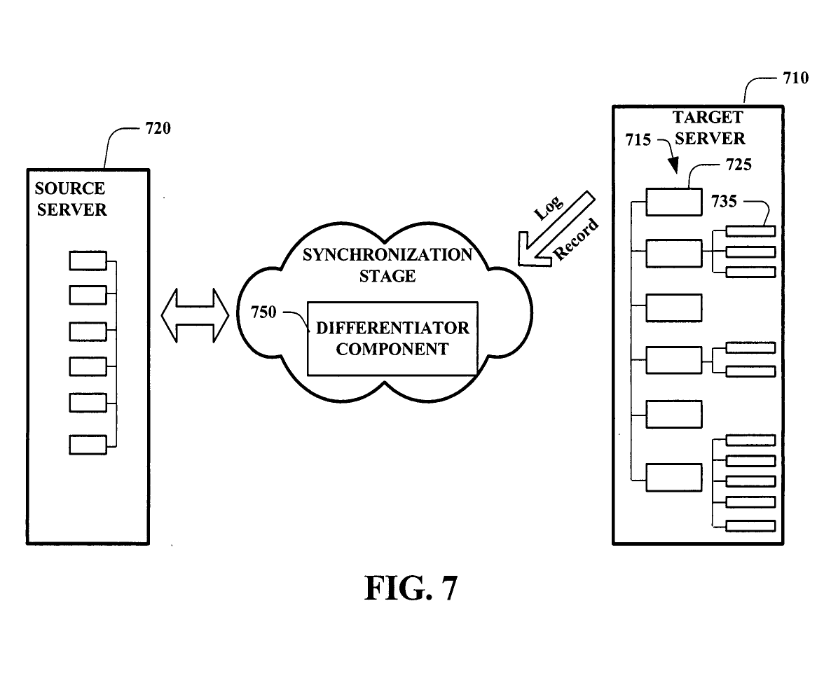

FIG. 7 illustrates a block diagram of a differentiator component 750 as part of synchronization according to one aspect of the present invention. The differentiator component can initially receive content of the target server 710 having an object hierarchy 715. The object of hierarchy 715 can include a plurality of container objects 725 and a number of leaf objects 735. Container or parent objects 725 can contain other objects, including other container objects as well. Leaf or child objects 735 can represent specific network or server resources. In addition, container objects can be created to accommodate any organizational arrangement. For example, a network administer may create folder objects representing sites, buildings, groups, or other meaningful organizational units. The user can then place an object representing a specific network entity in a particular folder object to identify the network entity. As noted, each of the objects in the server 710 and associated database can have properties or attributes. The object and its properties can be further broken down into segments that are stored into different data records and other distributed database configurations (not shown). Each of the data records can store the same number of bytes with logical elements stored in multiple data records. Accordingly, there can be different record types. For example, there can be records which contain object information (object records); records that contain property attributes (property records); records that contain information related to the association of partitions and replicas, (partition records), and the like. Also, objects can be stored as a “blob,” or raw piece of data, for faster retrieval and storage. The differentiator component 750 can compare contents of various records for target server 710 with that of the source server 720, and determine a difference of content that is then employed for restoring the target server 710.

The synchronization methodology of the present invention can also be employed for various computer-implemented data mining systems. Such systems can include an interface tier, an analysis tier, and a database tier, with associated server configurations. For example, the interface tier can support interaction with users, and includes an OLAP client, as described in detail supra, which can further provide a user interface for generating SQL statements that retrieve data from a database, and an analysis client that displays results from a data mining algorithm. In such configurations, the analysis tier can perform one or more data mining algorithms, and can include an OLAP server that schedules and prioritizes the SQL statements received from the OLAP Client, as well as an analytic server that schedules and invokes the data mining algorithm to analyze the data retrieved from the database, and a learning engine that performs a learning step of the data mining algorithm. The database tier can stores and manage the databases, and can further include an inference engine that performs an Inference step of the data mining algorithm, a relational database management system (RDBMS) that performs the SQL statements against a Data Mining view to retrieve the data from the database, and a model results table that stores the results of the data mining algorithm.

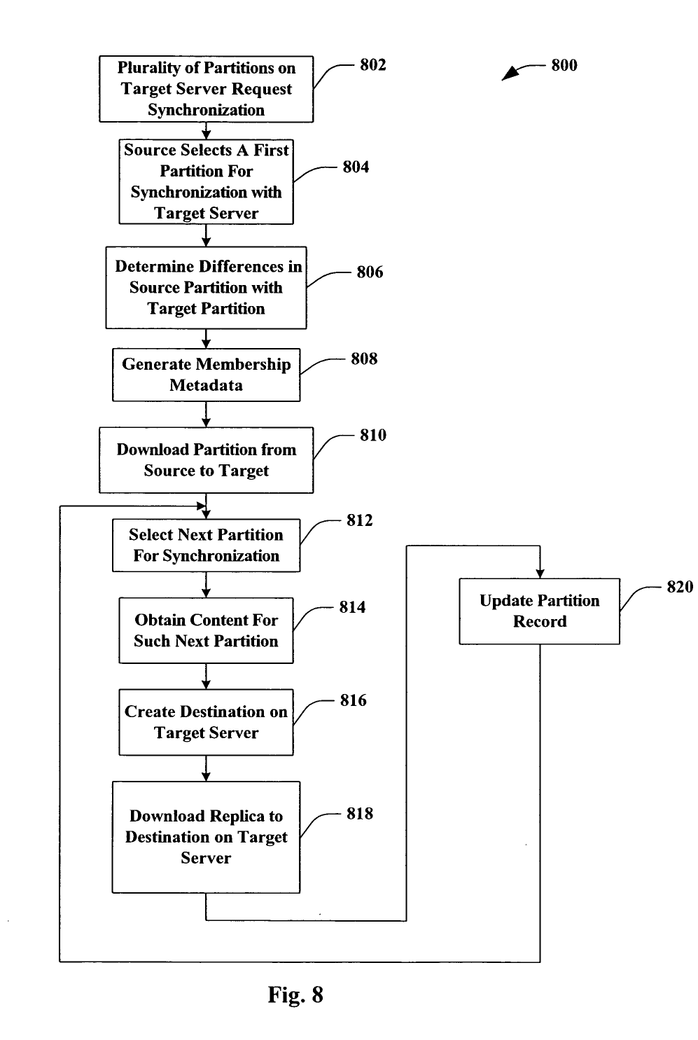

Referring now to FIG. 8, there is illustrated a flow chart 800 of a particular synchronization process of the present invention. Initially, at 802, a plurality of partitions 1 . . . N on the target server request synchronization with a source server, for example based on a command sent by the system administrator to the target server. At 804, the source selects a first of its partitions for back up on the target server, and configures a first destination on the target server (e.g., via a partition designator) for receiving such synchronized data. The selection process can be determined in a number of ways, including but not limited to, the source server partition that is first requested for synchronization, and/or utilizing a priority scheme of the target server partitions that are requesting synch-up. Once the first partition on the source server and the first destination for transferring synchronized data on the target server are selected, then at 806 the source determines the set of changes in the first source server partition with that on a target server—for example, the source determines differences between the source database and the target database utilizing the partition computation algorithm for examination in order to determine what changes will be propagated to selected destinations. At 808, a partition computation algorithm can create first membership metadata in the form of one or more metadata, and stores the membership metadata at the source. At 810, a first partition replica is downloaded to the first destination on the target server for a restoration thereof. Once restoring on the target server is completed, synchronization of the first destination is complete.

At 812, the source selects a next partition for synchronization based on request from the target source, and/or system administrator. At 814, contents of the next partition of the target server are then obtained (e.g., via an image or log record) by the source to determine if synchronization is even required for the next destination for this particular set of data. If so, at 816, the source utilizes the partition designator component, to create a second destination on the target server for transfer of the partition replica. At 818, the second partition replica is downloaded, and at 820, partition updating is performed to complete this portion of the synchronization process for the next destination. The process cycles back to the input at 812 to select a next partition and/or destination for synchronization.

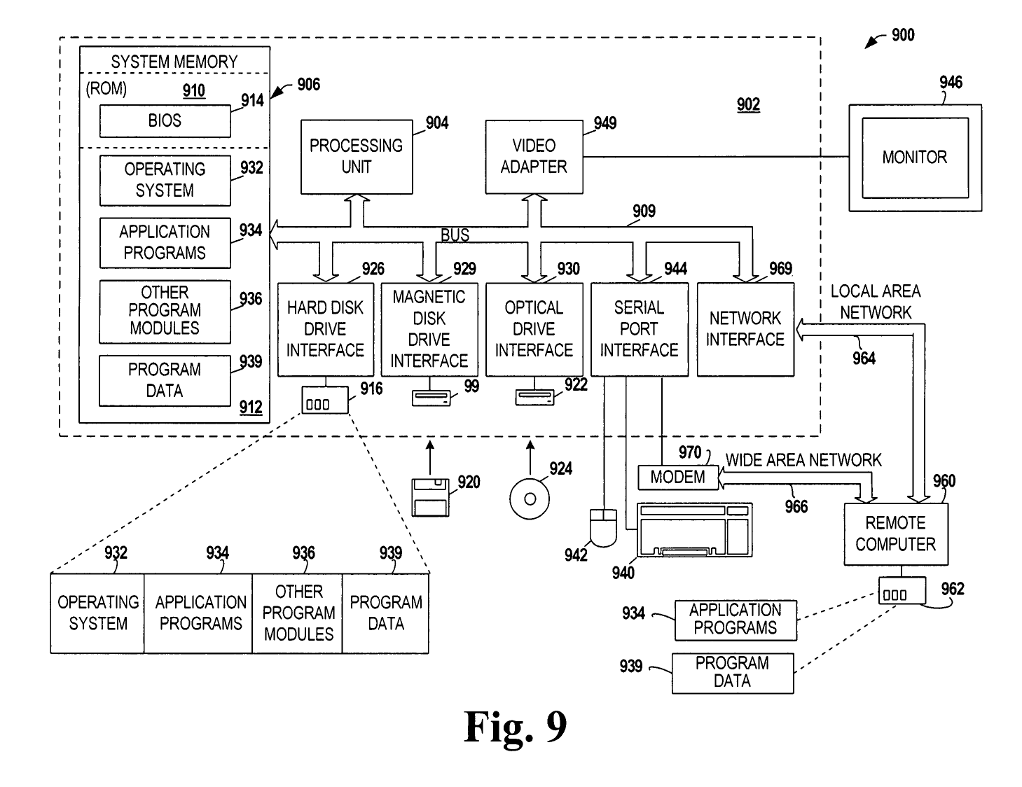

In order to provide additional context for implementing various aspects of the present invention, FIG. 9 and the following discussion are intended to provide a brief, general description of a suitable computing environment 900 in which the various aspects of the present invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

With reference to FIG. 9, an exemplary system environment 900 for implementing the various aspects of the invention includes a conventional computer 902, including a processing unit 904, a system memory 906, and a system bus 909 that couples various system components, including the system memory, to the processing unit 904. The processing unit 904 may be any commercially available or proprietary processor. In addition, the processing unit may be implemented as multi-processor formed of more than one processor, such as may be connected in parallel.

The system bus 909 may be any of several types of bus structure including a memory bus or memory controller, a peripheral bus, and a local bus using any of a variety of conventional bus architectures such as PCI, VESA, Microchannel, ISA, and EISA, to name a few. The system memory 906 includes read only memory (ROM) 910 and random access memory (RAM) 912. A basic input/output system (BIOS) 914, containing the basic routines that help to transfer information between elements within the computer 902, such as during start-up, is stored in ROM 910.

The computer 902 also may include, for example, a hard disk drive 916, a magnetic disk drive 99, e.g., to read from or write to a removable disk 920, and an optical disk drive 922, e.g., for reading from or writing to a CD-ROM disk 924 or other optical media. The hard disk drive 916, magnetic disk drive 99, and optical disk drive 922 are connected to the system bus 909 by a hard disk drive interface 926, a magnetic disk drive interface 929, and an optical drive interface 930, respectively. The drives 916-922 and their associated computer-readable media provide nonvolatile storage of data, data structures, computer-executable instructions, etc. for the computer 902. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment 900, and further that any such media may contain computer-executable instructions for performing the methods of the present invention.

A number of program modules may be stored in the drives 916-922 and RAM 912, including an operating system 932, one or more application programs 934, other program modules 936, and program data 939. The operating system 932 may be any suitable operating system or combination of operating systems. By way of example, the application programs 934 and program modules 936 can include a database serving system and/or a proactive caching system that utilizes data in accordance with an aspect of the present invention. Additionally, the program data 939 can include input data for controlling and/or biasing a proactive caching system in accordance with an aspect of the present invention.

A user can enter commands and information into the computer 902 through one or more user input devices, such as a keyboard 940 and a pointing device (e.g., a mouse 942). Other input devices (not shown) may include a microphone, a joystick, a game pad, a satellite dish, wireless remote, a scanner, or the like. These and other input devices are often connected to the processing unit 904 through a serial port interface 944 that is coupled to the system bus 909, but may be connected by other interfaces, such as a parallel port, a game port or a universal serial bus (USB). A monitor 946 or other type of display device is also connected to the system bus 909 via an interface, such as a video adapter 949. In addition to the monitor 946, the computer 902 may include other peripheral output devices (not shown), such as speakers, printers, etc.

It is to be appreciated that the computer 902 can operate in a networked environment using logical connections to one or more remote computers 960. The remote computer 960 may be a workstation, a server computer, a router, a peer device or other common network node, and typically includes many or all of the elements described relative to the computer 902, although, for purposes of brevity, only a memory storage device 962 is illustrated in FIG. 9. The logical connections depicted in FIG. 9 can include a local area network (LAN) 964 and a wide area network (WAN) 966. Such networking environments are commonplace in offices, enterprise-wide computer networks, intranets and the Internet.

When used in a LAN networking environment, for example, the computer 902 is connected to the local network 964 through a network interface or adapter 969. When used in a WAN networking environment, the computer 902 typically includes a modem (e.g., telephone, DSL, cable, etc.) 970, or is connected to a communications server on the LAN, or has other means for establishing communications over the WAN 966, such as the Internet. The modem 970, which can be internal or external relative to the computer 902, is connected to the system bus 909 via the serial port interface 944. In a networked environment, program modules (including application programs 934) and/or program data 939 can be stored in the remote memory storage device 962. It will be appreciated that the network connections shown are exemplary and other means (e.g., wired or wireless) of establishing a communications link between the computers 902 and 960 can be used when carrying out an aspect of the present invention.

In accordance with the practices of persons skilled in the art of computer programming, the present invention has been described with reference to acts and symbolic representations of operations that are performed by a computer, such as the computer 902 or remote computer 960, unless otherwise indicated. Such acts and operations are sometimes referred to as being computer-executed. It will be appreciated that the acts and symbolically represented operations include the manipulation by the processing unit 904 of electrical signals representing data bits which causes a resulting transformation or reduction of the electrical signal representation, and the maintenance of data bits at memory locations in the memory system (including the system memory 906, hard drive 916, floppy disks 920, CD-ROM 924, and remote memory 962) to thereby reconfigure or otherwise alter the computer system's operation, as well as other processing of signals. The memory locations where such data bits are maintained are physical locations that have particular electrical, magnetic, or optical properties corresponding to the data bits.

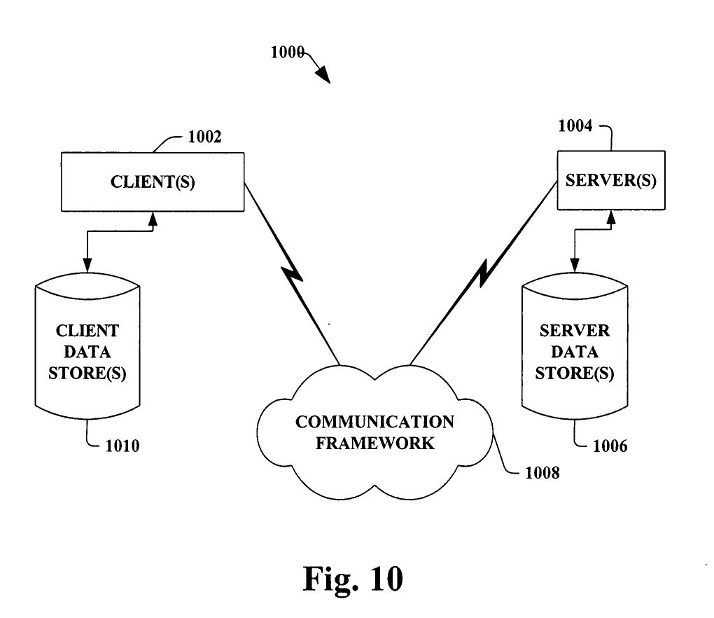

FIG. 10 is another block diagram of a sample computing environment 1000 with which the present invention can interact. The system 1000 further illustrates a system that includes one or more client(s) 1002. The client(s) 1002 can be hardware and/or software (e.g., threads, processes, computing devices). The system 1000 also includes one or more server(s) 1004. The server(s) 1004 can also be hardware and/or software (e.g., threads, processes, computing devices). The servers 1004 can house threads to perform transformations by employing the present invention, for example. One possible communication between a client 1002 and a server 1004 may be in the form of a data packet adapted to be transmitted between two or more computer processes. The system 1000 includes a communication framework 1008 that can be employed to facilitate communications between the client(s) 1002 and the server(s) 1004. The client(s) 1002 are operably connected to one or more client data store(s) 1010 that can be employed to store information local to the client(s) 1002. Similarly, the server(s) 1004 are operably connected to one or more server data store(s) 1006 that can be employed to store information local to the servers 1004.

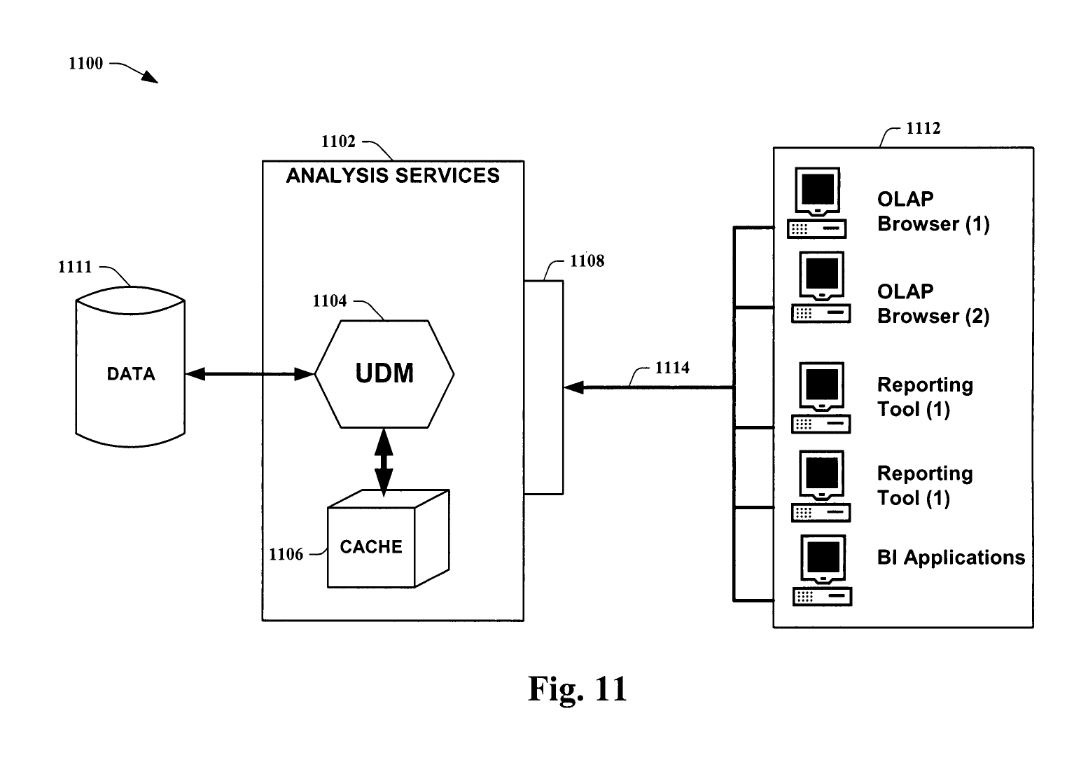

Turning to FIG. 11, an example operating environment 1100 in which the present invention can function is shown. This typical environment 1100 comprises an analysis services component 1102 linked to a data source 1111 and user interfaces 1112. The user interfaces 1112 are comprised of OLAP browsers, reporting tools, and other BI (Business Intelligence) applications and the like. The analysis services component 1102 typically has an interface 1114 with the user interfaces 1112 via interfaces 1108 like XML/A (eXtensible Markup Language/Analysis) and MDX (Multidimensional Exchange Language) and the like. The analysis services component 1102 is comprised of a UDM (Unified Dimensional Model) component 1104 and a cache 1106. In this example, the present invention is employed within the analysis services component 1102 via the UDM component 1104 and the cache 1106. The UDM component can proactively access the cache 1106 and/or the data directly.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A synchronization system comprising:
a transactional component that synchronizes a state of a target server and a source server, without an interruption of query processing to a plurality of clients serviced by the target server.

2. The synchronization system of claim 1 further comprising a partition designator component that reconfigures location of data to be synchronized on the target server during the synchronization process.

3. The synchronization system of claim 1 further comprising a differentiator component that determines a difference between a state of the target server and the source server.

4. The synchronization system of claim 1, the source server and the target server interact with relational databases.

5. The synchronization system of claim 1, the source server and the target server operate in a multidimensional environment.

6. The synchronization system of claim 5, the multidimensional environment comprises OLAP objects.

7. The synchronization system of claim 6, the multidimensional environment further comprising an analysis component with a Unified Dimensional Mode.

8. The synchronization system of claim 2 further comprising a registry partition system that provide access to stored information.

9. The synchronization system of claim 1, the state of the target server is updated via a partial synchronization performed between the target server and the source server.

10. The synchronization system of claim 1, the state of the target server is updated via a total synchronization performed between the target server and the source server.

11. The synchronization system of claim 1, the state of the target server and the source serer is synchronized by issuance of a single command.

12. The synchronization system of claim 1, the target server pulls data from the source server as part of a synchronization process.

13. The synchronization system of claim 3, the differentiator component operates on a log record provided by the target server.

14. A computer implemented method for synchronizing a state between a source server and a target server comprising:
restoring a target server that serves a plurality of clients to a state of a source server; and
maintaining a query processing service between the target server and the plurality of clients during the restoring act.

15. The method of claim 14 further comprising, sending a log record containing contents of the target server to the source server.

16. The method of claim 15 further comprising comparing the log record with contents of the source server.

17. The method of claim 16 further comprising determining a difference between the content of the target server with the content of the source server, and sending the difference to the target server.

18. The method of claim 14 further comprising building cache configurations on the target server that are different form the source server for data to be synchronized.

19. The method of claim 14 further comprising preserving a state of the data on the target server during the restoring act.

20. The method of claim 18 further comprising sending the difference in a compressed format to the source server.

21. A computer implemented method for synchronizing a target server with a source server comprising:
sending an image of a target server to a source server; the target server processing queries of a plurality of clients;
restoring portions of a target server to a state of a source server; and
maintaining query processing between the target server and the plurality of clients during the restoring act.

22. The method of claim 21 further comprising restoring all contents of the target server to a state of the source server.

23. The method of claim 21 further comprising synchronizing the target server with designated partitions of the source server.

24. The method of claim 23 further comprising pulling data from the source server by the target server.

25. The method of claim 23 further comprising distributing data from the source among a plurality of target server configurations.

26. A computer-based synchronization system comprising:
a transactional component that restores a state of a target server with that of a source server in a data mining environment, the target server maintains query processing to a plurality of clients serviced thereby during restoration period; and
a partition designator component that reconfigures location of data on the target server during the synchronization process.

27. The synchronization system of claim 26 further comprising a differentiator component that determines a difference between a state of the target server and the source server.

28. The synchronization system of claim 26, the data mining environment includes an OLAP server.

29. The synchronization system of claim 28, further comprising an analytic server that schedules and invokes a data mining algorithm to analyze retrieved data.

30. A computer-implemented method for synchronizing a target server with a source server comprising:
receiving a synchronization command by the source server form a target server that services a plurality of clients;
comparing a state of the target server with the source server;
performing a back up of the source server on the target server while the target server maintains query processing with the plurality of clients.

31. The method of claim 30 further comprising receiving a log record by the source server, the log record indicating contents of the target server.

32. The method of claim 30 further comprising determining a difference between the target server and the source server.

33. The method of claim 30 further comprising processing OLAP objects by the source server.

34. A system for synchronizing a target server with a source server comprising:
means for maintaining query processing to a plurality of clients of the target server during a synchronization process of the target server; and
means for restoring the target server with a state of the source server.

35. The system of claim 34 further comprising means for partitioning the target server based on a user's preference during the synchronization process.
